(19) United States
(12) Patent Application Publication
(10) Pub. No.: US 2006/0268357 A1
(43) Pub. Date: Nov. 30, 2006

(54) System and method for processing images using centralized image correction data

(76) Inventors: Dietrich Werner Vook, Los Altos, CA (US); John Stewart Wenstrand, Menlo Park, CA (US)

Correspondence Address: AVAGO TECHNOLOGIES, LTD., P.O. BOX 1920, DENVER, CO, 80201-1920, US

(21) Appl. No.: 11/136,941

(22) Filed: May 25, 2005

(51) Int. Cl. G06F 3/12; G03F 3/08

(52) U.S. Cl. 358/448; 358/1.15; 358/518

(57) ABSTRACT

An image processing system uses centralized image correction data to process digital images. The image processing system includes a centralized database for storing image correction data for imaging devices. An image processor that receives image data representing an image captured by one of the imaging devices accesses the centralized database with a key associated with the imaging device to retrieve the image correction data for the imaging device. The image processor processes the image data using the retrieved image correction data to correct the image data by reducing various noise components in the image.

### BACKGROUND OF THE INVENTION

Digital image sensors are predominantly of two types: CCD (Charge Coupled Devices) and CMOS-APS (Complementary Metal Oxide Semiconductor—Active Pixel Sensors). Both types of sensors typically contain an array of photo-detectors, arranged in a pattern, that generate electrical charge in response to light. Each photo-detector corresponds to a pixel of an image and measures the intensity of light of the pixel within one or ranges of wavelengths, corresponding to one or more perceived colors.

Despite advances in the manufacturing process, both CCD and CMOS image sensors often contain defects that produce undesirable noise in the image. For example, one significant source of noise in an image is known as “dark current noise.” Dark current noise is a fixed pattern noise that results from manufacturing defects in the photo-detectors. The defects cause the photo-detectors to accumulate charge even in the absence of light. Typically, the dark current in an image sensor creates an undesirable “dark” image that overlays the illuminated image.

Image sensors have traditionally employed a dark current subtraction mechanism to remove the effects of dark current in an image. For example, in cameras that provide a mechanical shutter, a dark image (dark frame) with the shutter closed is obtained along with the illuminated image (image frame) with the shutter open. The dark frame is subtracted from the image frame to yield an image frame without the dark noise component. In cameras that do not have a shutter, a dark noise image is stored on the image sensor and subtracted from each new image captured. An example of such a dark current subtraction process using a stored dark image is described in U.S. Pat. No. 6,714,241 to Baer, entitled “Efficient Dark Current Subtraction in an Image Sensor.” In the Baer patent, prior to subtraction, the stored dark noise image is scaled for the temperature and exposure time using the dark noise captured by a few rows of “black pixels” on the image sensor.

Another source of noise that is common in digital image sensors that utilize a color filter array (CFA) is color aliasing or color distortion. For example, one such CFA is described in U.S. Pat. No. 3,971,065 to Bayer (hereinafter referred to as the Bayer CFA). In the Bayer CFA, each pixel sees only one color: red, green or blue. To obtain all three primary colors at a single pixel location, it is necessary to interpolate colors from adjacent pixels. This process of interpolation is commonly referred to as demosaicing. Demosaiced images frequently exhibit color aliasing artifacts due to the inherent under-sampling of color on an image sensor fitted with a CFA, and there are numerous post-processing techniques designed to remove such color aliasing artifacts.

However, when the CFA itself contains defects that distort the color sensed at each pixel location, color aliasing artifacts in the image are prevalent even with various color aliasing removal techniques. For example, if the specifications of a color filter drift either in thickness or in spectral shape (absorbance vs. wavelength) from the manufacturing specifications, the color correction coefficients used in converting the R, G and B sensor values into the demosaiced image values may be incorrect. Thus, typically, manufacturers of CFA's provide color information on the color filters in the CFA for use in optimizing color correction matrices to more effectively remove color aliasing artifacts, thereby obtaining a truer color reproduction in the image.

In addition to the digital image sensor defects, various camera defects also contribute to the image noise. For example, one common source of noise in an image resulting from camera defects is lens distortion. Examples of lens distortion include pincushion distortion, barrel distortion and non-radial distortion. Traditionally, lens characterization information to correct for various types of lens distortion is obtained from the manufacturer and stored on the image sensor for use in various image processing algorithms to remove the effects of the lens distortion.

As the size of embedded digital cameras decreases, and as they are continually incorporated into other small, handheld electronic devices, such as cell phones, providing image correction data to correct for various image sensor defects and camera defects on the image sensor, as is done in digital still cameras, is not practical due to the relative cost of small amounts of nonvolatile memory (e.g., FLASH) in a CMOS based component. In addition, the added hardware needed to process all of the image correction data may increase the size of the image module beyond that allowable for the particular electronic device, especially in small “flip and stick” cell phones. Moreover, since these devices typically have small displays, any improvement to the image displayed on the hand-held display due to the image correction data and image processing is minimal. Therefore, the cost of the added hardware to store the image correction data in the camera module itself may outweigh any benefit provided to the customer. There is, therefore, a need for a cost-effective and practical image processing system to improve the quality of images by compensating for specific defects in the camera module.

### SUMMARY OF THE INVENTION

Embodiments of the present invention provide a cost-effective image processing system for processing images captured by various imaging devices. The image processing system includes a centralized database for storing image correction data for each of the imaging devices. The image processing system further includes an image processor for receiving original image data representing an image captured by one of the imaging devices and a key associated with that imaging device. The image processor is operable to access the centralized database to retrieve the image correction data for that imaging device using the key and process the original image data using the retrieved image correction data to produce corrected image data.

In one embodiment, the image processor is implemented in a web server connected to receive the original image data and the key from the imaging device via a data network. In another embodiment, the image processor is implemented in an image processing device connected to receive the original image data and the key from the imaging device and retrieve the image correction data from the centralized database via a data network. In a further embodiment, the image processor is implemented in an electronic device incorporating the imaging device, and the electronic device retrieves the image correction data from the centralized database via a data network.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 illustrates an exemplary imaging device, in accordance with embodiments of the present invention;

FIG. 2 is a block diagram of an exemplary image processing system for processing images using centralized image correction data, in accordance with embodiments of the present invention;

FIG. 3 is a block diagram of an exemplary image processing system implemented over a data network, in accordance with embodiments of the present invention;

FIG. 4 is a block diagram of an exemplary image processing system for processing images on image processing devices using remotely stored image correction data, in accordance with embodiments of the present invention;

FIG. 5 is a block diagram of an exemplary image processing system for processing images on electronic devices incorporating an imaging device using remotely stored image correction data, in accordance with embodiments of the present invention; and

FIG. 6 is a flowchart illustrating an exemplary process for processing images using centralized image correction data, in accordance with embodiments of the present invention.

### DETAILED DESCRIPTION OF EXEMPLARY EMBODIMENTS

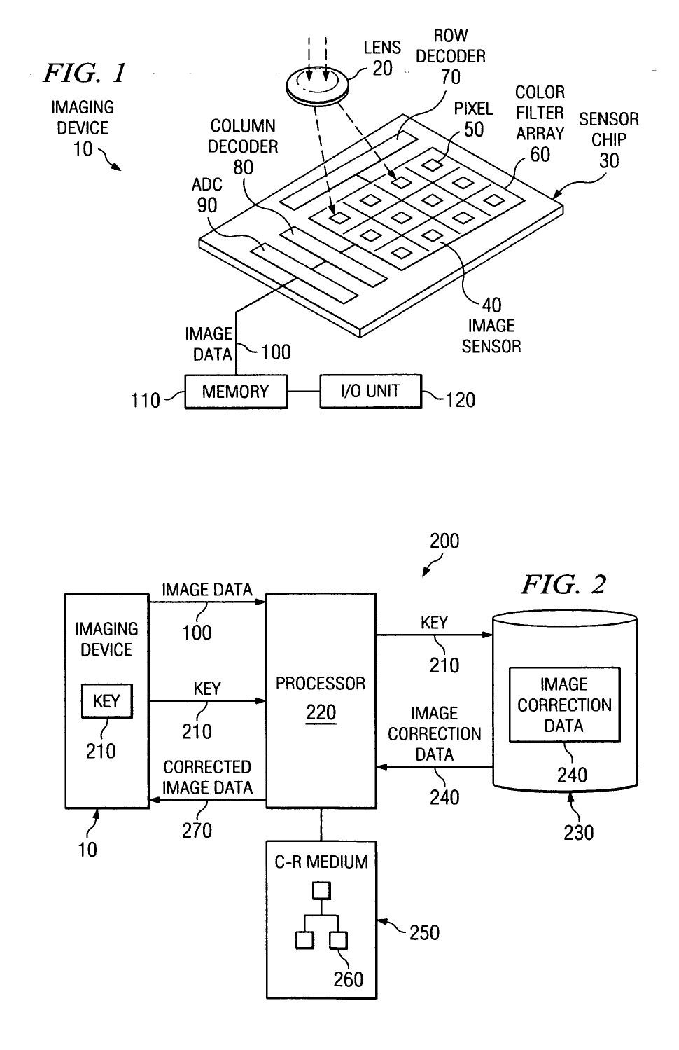

FIG. 1 illustrates an exemplary imaging device 10 for use in capturing an image that can be corrected using centralized image correction data, in accordance with embodiments of the present invention. The imaging device 10 can be incorporated into any electronic device, such as a cell phone, PDA, digital camera, video camera, medical imaging device or other similar electronic device. In addition, the imaging device 10 is capable of connecting to a computing device, such as a processing device, a personal computer, server, web server, or other similar computing device, to access the centralized image correction data to correct the captured image.

The imaging device 10 includes a lens 20 and an image sensor chip 30, such as a CMOS sensor chip or a CCD sensor chip. The sensor chip 300 includes a digital image sensor 40 having an array of photo-detectors 50, each corresponding to a pixel of an image projected thereon. The digital image sensor 40 is covered by a color filter array (CFA) 60, such that each pixel 50 senses only one color. In other embodiments, the digital image sensor 40 is not fitted with a CFA 60.

The lens 20 focuses light from a scene onto the array of photo-detectors 50. Each photo-detector 50 receives light through the lens 20, measures the intensity of received light as a pixel in an image of the scene and generates an analog signal representative thereof. Row decoder 70 and column decoder 80 select the rows and columns of the photo-detector array for reading the analog signals representing the pixel values and resetting the photo-detectors 50. The analog signal is converted to a corresponding digital image signal by an analog-to-digital converter (ADC) 90. For example, the ADC 320 can be a six-bit, eight-bit or ten-bit ADC 320. The digital image signal containing the raw or compressed image data 100 (i.e., raw or compressed sensor (pixel) values) is input to a memory 110 for storage therein. The memory 110 can be included on the sensor chip 30 or on a separate chip. In addition, the memory 110 can be any type of memory device, such as a flash ROM, EEPROM, ROM, RAM or any other type of storage device.

Furthermore, in an exemplary embodiment, the imaging device 10 further includes an I/O unit 120 for providing the image data 100 or other information to another system to assist in processing the image data 100. The I/O unit 120 can provide a direct wired connection to an external device, a networked connection to a remote device or a wireless connection to an external and/or remote device.

FIG. 2 is a block diagram illustrating an image processing system 200 for processing images using centralized image correction data 240, in accordance with embodiments of the present invention. The image processing system 200 is at least partially incorporated on a computer system, such as a personal computer, web server or other type of computing device. The image processing system 200 can also be partially incorporated as part of any digital imaging device, such as a cell phone, digital camera, video camera, medical imaging device, etc.

The image processing system 200 includes the imaging device 10, a processor 220 capable of executing an image correction algorithm 260 using image correction data 240 specifically tailored to the imaging device 10 and a computer-readable medium 250 for storing the image correction algorithm 260. The computer-readable medium 250 can be any type of memory device, such as a flash ROM, EEPROM, ROM, RAM or any other type of storage device. In another embodiment, the image correction algorithm 260 is stored in the processor 220, and the computer-readable medium 250 stores data used by the processor 220 during the image correction process. For example, the computer-readable medium 250 can store additional processing information (e.g., image data 100 and image correction data 240) for use by the processor 220 in executing the image correction algorithm 260.

The image processing system 200 further includes a centralized database 230 for storing the image correction data 240 for the imaging device 10. The image correction data 240 includes any data designed to compensate for defects in the imaging device 10. For example, the image correction data 240 can include dark current correction data for removing dark current in the image data 100 produced as a result of defects in the image sensor. For example, the image correction data 240 can include a dark current map that can be scaled to fit the current image using, for example, the technique described in U.S. Pat. No. 6,714,241 to Baer. In addition, the image correction data 240 can include color correction data for calibrating the color correction coefficients and reducing color aliasing artifacts in the image data 100 produced as a result of defects (module by module variations) in the CFA. Furthermore, the image correction data 240 can include lens correction data for reducing distortion in the image data 100 produced as a result of defects in the lens.

The centralized database 230 stores image correction data 240 for a plurality of imaging devices to reduce requirements for nonvolatile storage in the individual image modules incorporated into small hand-held devices, such as cell phones and PDAs. The image correction data 240 for a particular imaging device 10 is identified by a key 210 in the database 230. The key 210 is either stored in the imaging device 10 itself or manually input by a user of the imaging device 10. The key 210 is provided to the processor 220, along with the image data 100 (raw or compressed) representing an image captured by the imaging device 10. In other embodiments, the key 210 is stored in the processor 220 either directly or via the imaging device 10. The key 210 includes any type of identifier that uniquely identifies the imaging device 10. In one embodiment, the key 210 is associated with the serial number of the electronic device incorporating the imaging device 10. For example, in embodiments in which the electronic device is a cell phone, the key 210 can be the serial number or telephone number associated with the cell phone.

The processor 220 provides the key 210 to the database 230 to retrieve the image correction data 240 for the imaging device 10, and uses the image correction data 240 to process the raw image data 100 to produce corrected image data 270. The corrected image data 270 produces an image with a reduced noise component, thereby compensating for defects in the imaging device 10. In one embodiment, the corrected image data 270 is provided back to the imaging device 10 for storage and/or display. In another embodiment, the corrected image data 270 is output by the processor for subsequent storage in the computer-readable medium 250, subsequent printing and/or subsequent transmission of the corrected image data 270 to another device capable of storing, printing and/or displaying the image.

The processor 220 is a microprocessor, microcontroller, programmable logic device or any other type of processing device. In one embodiment, the processor 220 is built into the sensor chip incorporating the image sensor or otherwise included in the imaging device 10. In another embodiment, the processor 220 is part of a computing system that can be connected to the imaging device 10 via a wired or wireless interface. For example, in one embodiment, the processor 220 is included in an electronic device incorporating the imaging device 10. In another embodiment, the processor 220 is included in a personal computer connected to the electronic device (e.g., digital camera) incorporating the imaging device 10. In yet another embodiment, the processor 220 is at least partially included in a photo printing device for processing and printing the image. In still another embodiment, the processor 220 is at least partially included in a photo finishing device for processing the image, such as the photo finishing devices used by various photo finishing companies (e.g., SnapFish.com, Ofoto.com) and photo finishing devices found in various store-front kiosks.

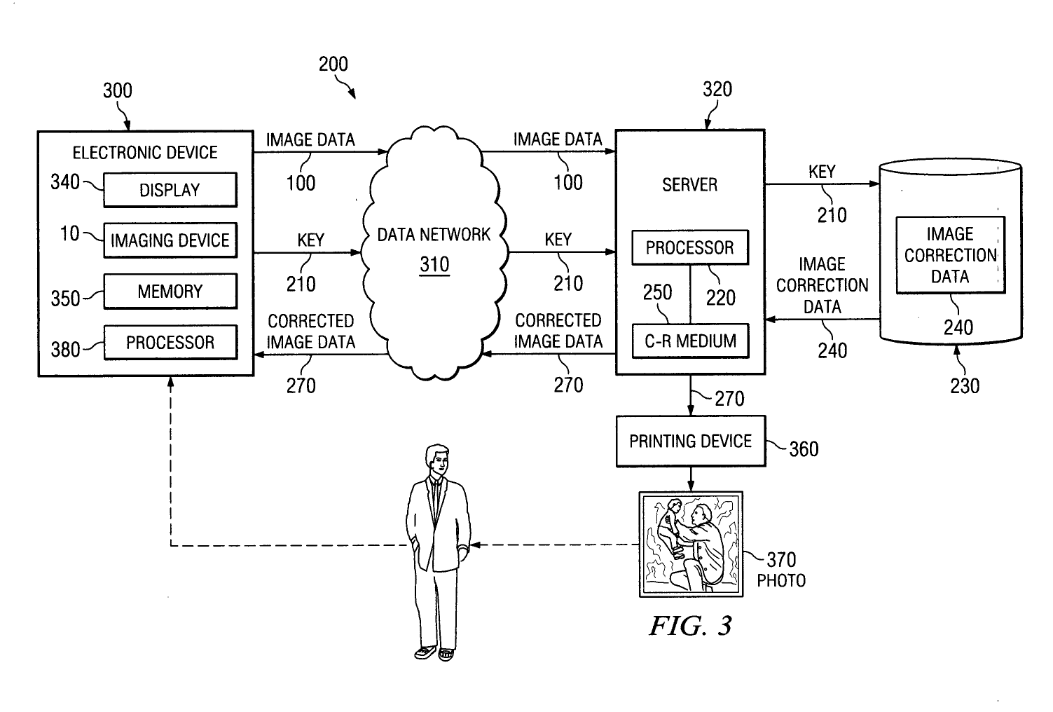

For example, as shown in FIG. 3, the image processing system 200 is implemented over a data network 310 (e.g., a local area network or the world-wide-web) to provide easily accessible image correction data 240 to process images captured by various imaging devices 10. In FIG. 3, the imaging device 10 is shown integrated with an electronic device 300, such as a cell phone, PDA, digital camera, video camera, medical imaging device or other similar electronic device 300. The electronic device 300 is connected to the data network 310 via a wired or wireless connection. For example, in embodiments in which the electronic device 300 is a cell phone, the cell phone provides a wireless connection to the data network 310 through a public or private wireless network. As another example, if the electronic device 300 is a digital camera, at least a portion of the imaging device 10 (e.g., the memory storing the raw image data 100 and the key 210) within the digital camera can directly connect to a personal computer, cell phone, photo finishing device or other similar device that provides a wired or wireless connection to the data network 310.

The electronic device 300 transmits the image data 100 (raw or compressed) representing an image and the key 210 associated with the imaging device 10 through the data network 310 to a web server 320 incorporating the processor 220 and computer-readable medium 250. The web server 320 provides the key 210 to the database 230 to retrieve the image correction data 240 for the imaging device 10, and passes the image correction data 240 to the processor 220 for use in processing the image data 100 to produce the corrected image data 270. In one embodiment, the corrected image data 270 is provided back to the electronic device for storage in a memory 350 therein or display on a display 340 of the electronic device 300. In another embodiment, the corrected image data 270 is output by the web server 320 to a printing device 360 for printing a photograph 370 of the image using the corrected image data 270.

For example, several on-line photo finishing companies offer services that allow users to up-load image data for one or more images and select certain images to print as photographs 370. The on-line photo finishing companies typically mail the printed photographs 370 to the users. As another example, store-front photo finishing kiosks typically provide an interface for users to up-load image data from a disk or CD and select certain images to print as photographs 370 on-site. The photo finishing kiosk can transmit the image data 100 (raw or compressed) for a particular image to the server 320 (e.g., a web server, local area network server, or other remote server) via the data network 310 and receive the corrected image data 270 from the server 320 for printing the photographs 370 at the kiosk.

In a further embodiment, the electronic device 300 includes an additional processor 380 operable to receive the image data 100 and the key 210 from the imaging device 10 and to automatically transfer the image data 100 and the key 210 to the processor 220. For example, in embodiments in which the electronic device 300 is a cell phone, there are applications currently available that can automatically transfer images to a personal computer via an RF link, e.g., Bluetooth. In accordance with embodiments of the present invention, the additional processor 380 shown in FIG. 3 can be included in the cell phone itself to automatically transfer images to the server 320 for processing and printing or included in a personal computer to provide a local client that automatically transfers images to the server 320 for processing and printing.

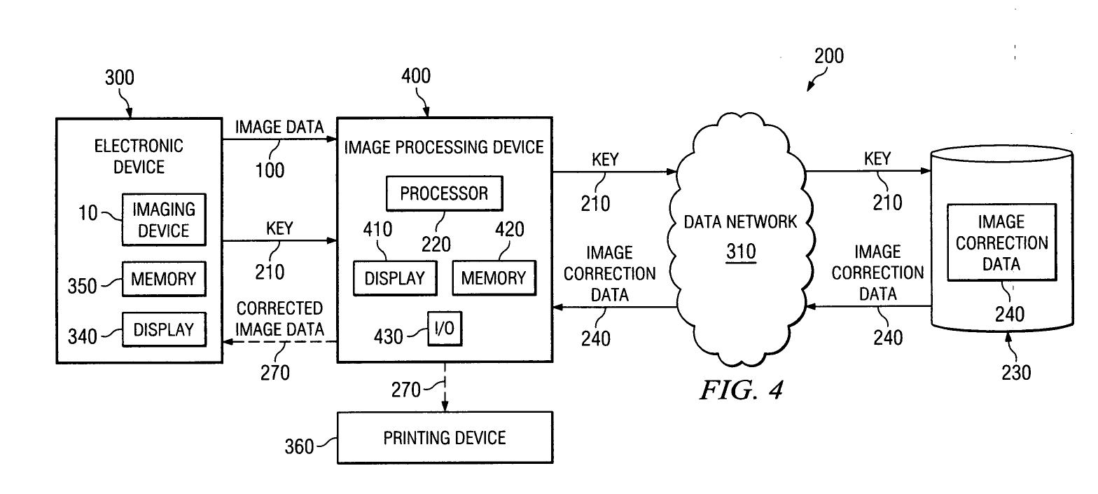

FIG. 4 illustrates another exemplary image processing system 200 for processing images using centralized image correction data 240 accessible through a data network 310. In FIG. 4, the electronic device 300 incorporating the imaging device 10 is shown connected to an image processing device 400. The image processing device 400 includes the processor 220 for processing the image data 100 and producing the corrected image data 270. The image processing device 400 is connected to the data network 310 via a wired or wireless connection. For example, in embodiments in which the electronic device 300 is a digital camera, the image processing device 400 can include a store-front photo finishing kiosk that provides a wired or wireless connection to the data network 310. The key 210 and image data 100 representing an image can be retrieved from the digital camera 300, stored on a disk or CD and up-loaded to the store-front photo finishing kiosk. As another example, the image processing device 400 can include a personal computer, cell phone, photo finishing device or other similar device that can be connected to the electronic device 300 to retrieve the key 210 and image data 100 and that provides a wired or wireless connection to the data network 310.

The image processing device 400 transmits the key 210 associated with the imaging device 10 through the data network 310 to the database 230 to retrieve the image correction data 240 for the imaging device 10. In one embodiment, the database 230 is directly accessible through the data network 310. In another embodiment, the database 230 is indirectly accessible through a server or other network interface. The image processing system 400 uses the image correction data 240 to process the image data 100 and produce the corrected image data 270.

In one embodiment, the corrected image data 270 is provided back to the electronic device 300 for storage in a memory 350 therein or display on a display 340 of the electronic device 300. In another embodiment, the corrected image data 270 is stored in a memory 420, which can be the same as the computer-readable medium 250 storing the image correction algorithm 260 (shown in FIG. 2), of the image processing device 400 and/or displayed on a display 410 of the image processing device 400. In another embodiment, the corrected image data 270 is output through an I/O unit 430 of the image processing device 400 to a printing device 360 (e.g., a photo printer attached to a personal computer or store-front kiosk) for printing a photograph of the image using the corrected image data 270.

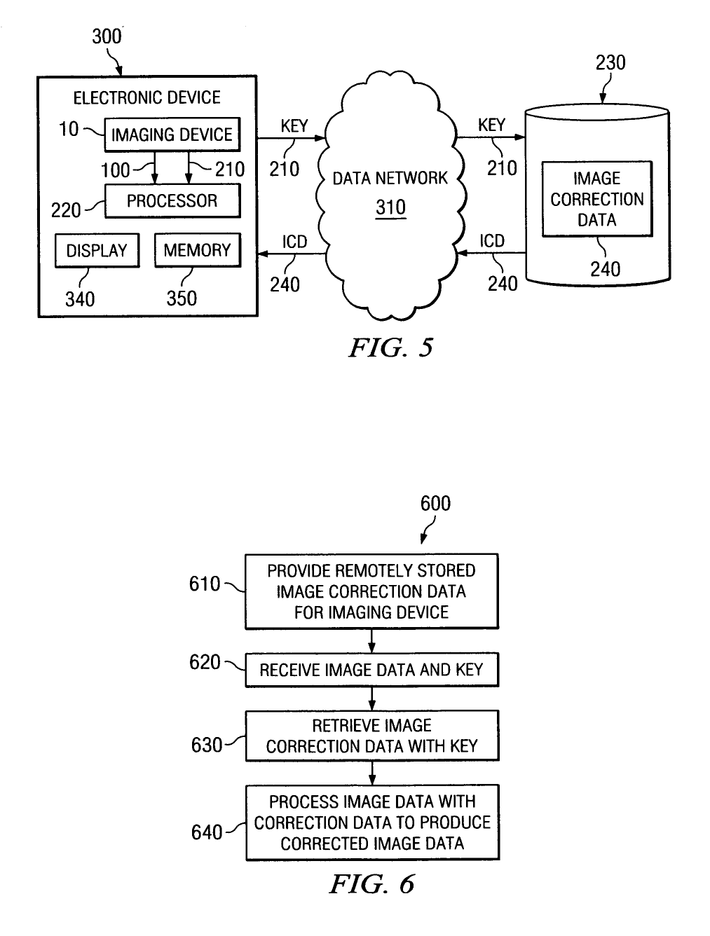

FIG. 5 is a block diagram of another exemplary image processing system 200 for processing images on electronic devices 300 incorporating an imaging device 10 using remotely stored image correction data 240, in accordance with embodiments of the present invention. In FIG. 5, the electronic device 300 incorporating the imaging device 10 is shown connected to the data network 310 to access the database 230 storing the image correction data 240 for the imaging device 10. The electronic device 300 is connected to the data network 310 via a wired or wireless connection. For example, in embodiments in which the electronic device 300 is a cell phone, the cell phone provides a wireless connection to the data network 310 through a public or private wireless network.

The electronic device 300 further includes the processor 220 for processing the image data 100 and providing the key 210 associated with the imaging device 10 to the database 230 for retrieval of the image correction data 240 associated with the imaging device 10. The processor 220 can be integrated on the image sensor chip or can be separate from the image sensor. The electronic device 300 transmits the key 210 associated with the imaging device 10 through the data network 310 to the database 230 to retrieve the image correction data 240 for the imaging device 10. In one embodiment, the database 230 is directly accessible through the data network 310. In another embodiment, the database 230 is indirectly accessible through a server or other network interface. The processor 220 on the electronic device 300 uses the retrieved image correction data 240 to process the image data 100 and produce the corrected image data 270. The corrected image data 270 can be stored in a memory 350 within the electronic device 300 and/or displayed on a display 340 of the electronic device 300. The memory 340 can be the same as the computer-readable medium 250 storing the image correction algorithm 260 (shown in FIG. 2) and/or the same as the memory 110 for storing the image data 100 (shown in FIG. 1). In addition, although not shown, the corrected image data 270 can be output to another device (e.g., a printer or personal computer) or transmitted to another device (e.g., another cell phone over the data network 310).

FIG. 6 is a flowchart illustrating an exemplary process 400 for processing images using centralized image correction data, in accordance with embodiments of the present invention. Initially, at block 610, image correction data for a particular imaging device is collected and stored in a centralized database remote from the imaging device. The image correction data can be determined during testing of the imaging device and can be provided by the manufacturer of the imaging device. For example, the image correction data can include dark current correction data, color correction data, lens correction data and other types of correction data for use in removing noise in an image caused by defects in the imaging device. The image correction data is associated with the imaging device in the database using a key unique to the imaging device.

At block 620, an image is acquired by the imaging device, and image data representing the image and the key associated with the imaging device are provided to an image processing system for processing the image to remove noise from the image. At block 630, the image correction data for the imaging device is retrieved from the centralized database using the key associated with the imaging device, and at block 640, the image processing system processes the image data using the retrieved image correction data to produce corrected image data with reduced noise.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. An image processing system for processing images captured by imaging devices, comprising:
a centralized database for storing image correction data for each of said imaging devices; and
an image processor for receiving original image data representing an image captured by one of said imaging devices and a key associated with said one of said imaging devices, wherein said image processor is operable to access said centralized database to retrieve said image correction data for said one of said imaging devices using said key and process said original image data using said image correction data for said one of said imaging devices to produce corrected image data representing said image.

2. The system of claim 1, wherein said one of said imaging devices includes an image sensor operable to receive light from a scene and produce said original image data representing said image thereof and a lens operable to focus said light on said image sensor.

3. The system of claim 2, wherein said image correction data includes dark current correction data for removing dark current in said original image data produced as a result of defects in said image sensor.

4. The system of claim 2, wherein said image correction data includes color correction data for optimizing color in said original image data by compensating for defects in a color filter array associated with said image sensor.

5. The system of claim 2, wherein said image correction data includes lens correction data for reducing distortion in said original image data produced as a result of defects in said lens.

6. The system of claim 1, wherein said key includes an identifier for said imaging device.

7. The system of claim 1, wherein said imaging device is incorporated on an electronic device, and wherein said key includes an identifier for said electronic device.

8. The system of claim 1, wherein said image processor is implemented in a server connected to receive said original image data and said key from said one of said imaging devices via a data network.

9. The system of claim 8, wherein said image processor is further operable to provide said corrected image data to an image printing device for printing a photograph of said image using said corrected image data.

10. The system of claim 1, wherein said image processor is implemented in an image processing device connected to receive said original image data and said key from said one of said imaging devices and retrieve said image correction data from said centralized database via a data network.

11. The system of claim 10, wherein said image processing device includes a display for displaying said image using said corrected image data.

12. The system of claim 10, wherein said image processing device is included in a computing device.

13. The system of claim 10, wherein said image processing device is included in a photo finishing device.

14. The system of claim 1, wherein said image processor is implemented in an electronic device incorporating said one of said imaging devices, and wherein said electronic device is operable to retrieve said image correction data from said centralized database via a data network.

15. The system of claim 1, further comprising:
an additional processor for receiving at least said original image data from said one of said imaging devices, and wherein said additional processor is operable to automatically transfer said original image data and said key to said image processor.

16. A method for processing images captured by an imaging device, comprising:
providing access to remotely stored image correction data for said imaging device;
receiving original image data representing an image captured said imaging device and a key associated with said imaging device;
retrieving said image correction data for said imaging device using said key; and
processing said original image data using said image correction data for said imaging device to produce corrected image data representing said image.

17. The method of claim 16, wherein said receiving said original image data and said key further comprises:
receiving said original image data and said key at a web server via a data network.

18. The method of claim 17, further comprising:
providing said corrected image data to an image printing device for printing a photograph of said image using said corrected image data.

19. The method of claim 16, wherein said retrieving said corrected image data further comprises:
retrieving said image correction data from a centralized database storing said image correction data via a data network.

20. The method of claim 19, wherein said receiving said original image data and said key further comprises:
automatically transferring said original image data and said key via a data network.

21. A computer-readable medium storing computer-executable instructions operable to implement a method for processing images captured by an image device, said method comprising:
providing access to remotely stored image correction data for said imaging device;
receiving original image data representing an image captured said imaging device and a key associated with said imaging device;
retrieving said image correction data for said imaging device using said key; and
processing said original image data using said image correction data for said imaging device to produce corrected image data representing said image.
